(19) United States
(12) Patent Application Publication
(10) Pub. No.: US 2026/0362358 A1
(43) Pub. Date: Nov. 12, 2026

(54) METHOD AND APPARATUS FOR SELECTING POLICY CONTROL FUNCTION IN WIRELESS COMMUNICATION SYSTEM SUPPORTING INTERWORKING BETWEEN NETWORKS

(71) Applicant: Samsung Electronics Co., Ltd., Suwon-si, Gyeonggi-do (KR)

(72) Inventors: Dongyeon KIM, Suwon-si (KR); Jungshin PARK, Suwon-si (KR); Jicheol LEE, Suwon-si (KR)

(21) Appl. No.: 19/122,531

(22) PCT Filed: Oct. 18, 2023
(86) PCT No.: PCT/KR2023/016176

§ 371 Date: Apr. 18, 2025

(30) Foreign Application Priority Data
Oct. 19, 2022 (KR) 10-2022-0135267

(51) Int. Cl. H04W 60/00

(52) U.S. Cl. CPC H04W 60/005

(57) ABSTRACT

The present disclosure relates to a method and apparatus for selecting a policy control function (PCF) in a wireless communication system supporting interworking between different networks, and according to an embodiment of the present disclosure, a method performed by a session management (SM)-PCF in a wireless communication system supporting interworking between a first network and a second network comprises the steps of: receiving a request message for a session management policy modification, the request message including information related to a radio access technology (RAT) change of a user equipment that moves form the first network to the second network, from a first network entity that has received a PDU session establishment request from the user equipment; determining whether a PCT used in the first network for the user equipment is used in the second network; and transmitting, to the first network entity, a response message including related information associated with a user equipment policy, on the basis of the determination.

### CROSS-REFERENCE TO RELATED APPLICATION(S)

This application is a U.S. National Stage application under 35 U.S.C. § 371 of an International application number PCT/KR2023/016176, filed on Oct. 18, 2023, which is based on and claims priority of a Korean patent application number 10-2022-0135267, filed on Oct. 19, 2022, in the Korean Intellectual Property Office, the disclosure of which is incorporated by reference herein in its entirety.

### TECHNICAL FIELD

The disclosure relates to a method and apparatus for providing user equipment policy (UE policy) information in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

A 5G system (5GS) that is a network recently commercialized and long-term evolution (LTE) and LTE-advanced (LTE-A) systems that currently provide mobile communication services are mobile communication systems that provide packet-based services. The 5GS is being developed to support interworking with an evolved packet system (EPS) based on LTE and LTE-A. In the disclosure, the 5GS may be referred to as a 5G system. In the 5G system, a 5G core (5GC) network may provide a UE policy to a user equipment (UE).

In the 5G system, interworking between the EPS and the 5GS may be supported for a UE that is capable of using wireless communication via the 5GS and/or EPS. When the UE that previously connected to an EPS network is connected to a 5GS network (i.e., when the UE moves from the EPS to the 5GS), an AMF of the 5GS may select a new policy control function (new PCF) for the UE in the state in which an old PCF that provided UE policy information to the UE in the EPS exists. In this instance, a plurality of PCFs, the old PCF and the new PCF, exist for the single UE, and thus UE policy information provided to the UE may conflict.

Therefore, the disclosure provides a method and apparatus for selecting a PCF in a wireless communication system that supports interworking between different networks.

In addition, the disclosure provides a method and apparatus for efficiently/stably selecting a PCF when a network access of a UE is moved from the EPS to the 5GS in a wireless communication system that supports interworking between the EPS and the 5GS.

### Technical Solution

According to an embodiment of the disclosure, a method performed by an access and mobility management function (AMF) in a wireless communication system that supports interworking between a first network and a second network may include an operation of receiving a UE registration request message from a UE that moves from the first network to the second network, an operation of obtaining second address information related to a second interface for accessing a first PCF based on first address information related to a first interface for accessing the first policy control function (PCF) used in the first network, an operation of performing, based on the second address information, a policy association establishment procedure with respect to the first PCF, an operation of transmitting a request message, including information related to a change of a radio access technology (RAT) of the UE, to a first network entity that manages a protocol data unit (PDU) session for the UE in the second network, and an operation of receiving a response message including UE policy association related information from the first network entity.

According to an embodiment of the disclosure, an access and mobility management function (AMF) in a wireless communication system that supports interworking between a first network and a second network may include a transceiver and a processor configured to receive, via the transceiver, a UE registration request message from a UE that moves from the first network to the second network, to obtain second address information related to a second interface for accessing a first PCF based on first address information related to a first interface for accessing the first policy control function (PCF) used in the first network, to perform, based on the second address information, a policy association establishment procedure with respect to the first PCF, to transmit, via the transceiver, a request message including information related to a change of a radio access technology (RAT) of the UE to a first network entity that manages a protocol data unit (PDU) session for the UE in the second network, and to receive, via the transceiver, a response message including UE policy association related information from the first network entity.

According to an embodiment of the disclosure, a method performed by a session management-policy control entity (session management-policy control function (SM-PCF)) in a wireless communication system that supports interworking between a first network and a second network may include an operation of receiving a request message, including information related to a change of a radio access technology (RAT) of a UE, for modifying a session management policy, from a first network entity that receives a PDU session establishment request from the UE that moves from the first network to the second network, an operation of determining whether a policy control function (PCF) used in the first network for the UE is used in the second network, and an operation of transmitting, based on the determination, a response message including UE policy association related information to the first network entity.

According to an embodiment of the disclosure, a session management-policy control entity (session management-policy control function (SM-PCF)) in a wireless communication system that supports interworking between a first network and a second network may include a transceiver and a processor configured to receive, via the transceiver, a request message, including information related to a change of a radio access technology (RAT) of a UE, for modifying a session management policy, from a first network entity that receives a PDU session establishment request from the UE that moves from the first network to the second network, to determine whether a policy control function (PCF) used in the first network for the UE is used in the second network, and to transmit, based on the determination, a response message including UE policy association related information to the first network entity via the transceiver.

### BRIEF DESCRIPTION OF DRAWINGS

FIG. 1 is a diagram illustrating a network structure and interfaces of a 5G system according to an embodiment of the disclosure;

FIG. 2 is a diagram illustrating a network structure and interfaces of a wireless communication system that supports interworking between an EPS and a 5GS according to an embodiment of the disclosure;

FIG. 3 is a diagram illustrating a network structure and interfaces in association with a policy control and charging control system of a 5G system according to an embodiment of the disclosure;

FIG. 4 is a diagram illustrating a network access procedure in a wireless communication system that supports interworking between an EPS and a 5GS that support UE policy management according to an embodiment of the disclosure;

FIGS. 5A, 5B, 5C, 6A, 6B, 6C, 7A, 7B, and 7C are diagrams illustrating procedures that manage a UE policy association during a process in which a UE moves core network access from an EPS to a 5GS in a wireless communication system that supports interworking between the EPS and the 5GS, according to various embodiments of the disclosure; and

FIG. 8 is a diagram illustrating an example of a configuration of a network entity in a wireless communication system according to an embodiment of the disclosure.

### MODE FOR CARRYING OUT THE INVENTION

In describing embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help an understanding of the disclosure and the disclosure is not limited to configurations or arrangements illustrated in the drawings of the disclosure. In addition, a detailed description of known functions or configurations that may make the subject matter of the disclosure unclear will be omitted. It should be noted that, in the following description, only parts required to understand operations according to various embodiments will be described and a description of the other parts will be omitted so as not to make the subject matter of the disclosure obscure. Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

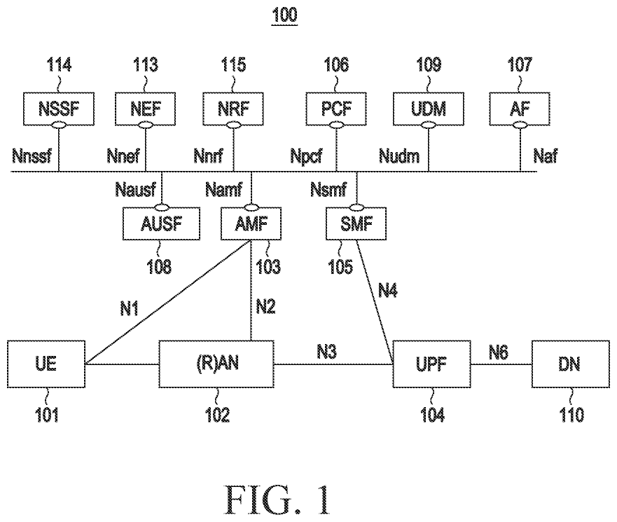

In the disclosure, for the network technology, reference has been made to the standards (e.g., TS 23.501, TS 23.502, TS 23.503, or the like) defined by International Telecommunication Union (ITU) or 3GPP. Components included in the network structure of FIG. 1 may be physical entities, software performing individual functions, or hardware combined with software. The reference numeral N1, N2, N3, . . . Nx, or the like in drawings are the publicly known interfaces between the NFs in a 5G core network (CN).

FIG. 1 is a diagram illustrating a network structure and interfaces of a 5G system according to an embodiment of the disclosure.

A network entity included in the network structure of the 5G system of FIG. 1 may include a network function (NF) depending on implementation of the system.

Referring to FIG. 1, the network structure of the 5G system may include various network entities. For example, the 5G system may include an authentication server function (AUSF) 108, an access and mobility management function ((core) access and mobility management function (AMF)) 103, a session management function (SMF) 105, a policy control function (PCF) 106, an application function (AF) 107, a unified data management (UDM) 109, a data network (DN) 110, a network exposure function (NEF) 113, a network slicing selection function (NSSF) 114, an edge application service domain repository (EDR) 113, an edge application server (EAS) (not illustrated), an EAS discovery function (EASDF) (not illustrated), a user plane function (UPF) 104, a (radio) access network ((R)AN)) 102, and a user equipment (UE) (or terminal) 101.

The NFs of the 5G system may support the following functions.

The AUSF 108 may process and store data for authenticating the UE 101.

The AMF 103 may provide an access and mobility management function in units of UEs, and one AMF may be basically accessed by one UE. Specifically, the AMF 103 may support functions such as signaling between CN nodes for mobility among 3GPP access networks, termination of a radio access network (RAN) CP interface (i.e., N2 interface), termination of non access stratum (NAS) signaling (N1), NAS signaling security (NAS ciphering and integrity protection), AS security control, registration management (registration area management), connection management, idle mode UE reachability (including controlling and performing of paging retransmission), mobility management control (subscription and policy), supporting of intra-system mobility and inter-system mobility, supporting of network slicing, selecting of an SMF, lawful intercept (L1) (with respect to an AMF event and an interface to an L1 system), providing delivery of a session management (SM) message between a UE and an SMF, a transparent proxy for routing a session management (SM) message, access authentication, access authorization including checking of the right of roaming, providing delivery of an SMS message between a UE and an SMSF, a security anchor function (SAF), and/or security context management (SCM). Some or all of the functions of the AMF 103 may be supported in a single instance of a single AMF.

The DN 110 may be, for example, an operator service, an Internet access or 3^{rd} party service, or the like. The DN 110 may transmit a downlink protocol data unit (PDU) to the UPF 104, or may receive, from the UPF 104, a PDU transmitted from the UE 101.

The PCF 106 may receive information associated with a packet flow from an application server, and may provide a function of determining a policy associated with mobility management, session management, or the like. Specifically, the PCF 106 may support functions, such as supporting a unified policy framework to control network operations, providing policy rules so that a control plane function(s) (e.g., AMF, SMF, or the like) implements the policy rules, implementing a front end for accessing related subscription information for determining a policy in a user data repository (UDR), or the like.

The SMF 105 may provide a session management function, and in the case in which the UE 101 has a plurality of sessions, each session may be managed by each different SMF. Specifically, the SMF 105 may support functions, such as session management (e.g., session establishment, modification, and release including maintaining a tunnel between the UPF 104 and the (R)AN node 102), UE IP address allocation and management (selectively including authentication), selecting and controlling a user plane (UP) function, setting a traffic steering for routing traffic from the UPF 104 to an appropriate destination, termination of an interface for policy control functions, performing a control part of a policy and quality of service (QoS), lawful interception (LI) (with respect to an SM event and an interface to an L1 system), termination of an SM part of a NAS message, downlink data notification, an initiator of access network (AN)-specific SM information (transferring to the (R)AN 102 through N2 via the AMF 103), determining a session and service continuity (SSC) mode, a roaming function, and the like. Some or all of the functions of the SMF 105 may be supported in a single instance of a single SMF.

The UDM 109 may store user subscription data, policy data, and the like. The UDM 109 may include two parts, that is, an application front end (FE) (not illustrated) and a user data repository (UDR) (not illustrated).

The front end (FE) (not illustrated) may include a UDM FE that is in charge of location management, subscription management, credential processing, and the like, and may include a PCF that is in charge of policy control. The UDR may store data required for functions provided by the UDM-FE and may store a policy profile required by the PCF. The data stored in the UDR may include user subscription data including a subscription identifier, a security credential, access and mobility related subscription data, and session-related subscription data, and may include policy data. The UDM-FE may support functions, such as accessing subscription information stored in the UDR, authentication credential processing, user identification handling, access authentication, registration/mobility management, subscription management, SMS management, and the like.

The UPF 104 may transfer a downlink PDU received from the DN 110 to the UE 101 via the (R)AN 102, and may transfer, to the DN 110, an uplink PDU received from the UE 101 via the (R)AN 102. Specifically, the UPF 104 may support functions, such as an anchor point for intra/inter RAT mobility, an external PDU session point of interconnection (interconnect) with a data network, packet routing and forwarding, a user plane part of implementation of policy rules and packet inspection, lawful intercept, traffic usage reporting, an uplink classifier for supporting routing of a traffic flow to a data network, a branching point for supporting a multi-homed PDU session, QoS handling for a user plane (e.g., packet filtering, gating, implementing uplink/downlink rate), uplink traffic verification (an SDF mapping between a service data flow (SDF) and a QoS flow), transport level packet marking in an uplink and downlink, downlink packet buffering, triggering of a downlink data notification, and the like. Some or all of the functions of the UPF 104 may be supported in a single instance of a single UPF.

The AF 107 may interoperate with a 3GPP core network in order to provide a service (e.g., supporting functions such as application effect on traffic routing, accessing network capability exposure, interoperating with a policy framework for policy control, or the like).

The (R)AN 102 is the genetic term of a new radio access network that supports both evolved E-UTRA (E-UTRA), which is an evolved version of the 4G radio access technology, and new radio (NR) (e.g., gNB).

The gNB supports functions for radio resource management (i.e., radio bearer control, radio admission control, connection mobility control, dynamic allocation of resources (i.e., scheduling) to a UE in an uplink/downlink), internet protocol (IP) header compression, user data stream encryption and integrity protection, selecting an AMF in the case of attachment of a UE if routing to the AMF is not determined based on information provided to the UE, user plane data routing to a UPF(s), control plane information routing to an AMF, connection setup and release, scheduling and transmitting of a paging message (generated from an AMF), scheduling and transmitting of system broadcast information (generated from an AMF or operating and maintenance (O&M)), measuring for mobility and scheduling and configuring of a measurement report, transport level packet marking in an uplink, session management, supporting of network slicing, QoS flow management and mapping to a data radio bearer, supporting of a UE in an inactive mode, distributing of a NAS message, a NAS node selecting function, sharing of a radio access network, dual connectivity, tight interworking between NR and E-UTRA, and the like.

The UE 101 may be a user equipment. The UE may also be referred to as a UE, a mobile equipment (ME), a mobile station (MS), and the like. In addition, the user equipment may be a portable device such as a notebook, a portable phone, a personal digital assistant (PDA), a smartphone, a multi-media device, or the like, or may be a non-portable device such as a personal computer (PC), an in-vehicle device, or the like.

The NEF 111 may provide a function for safely exposing, for example, services and capabilities for a 3rd party, internal exposure/re-exposure, an application function, and edge computing, provided by 3GPP network functions. The NEF 111 may receive information (information based on exposed capability (capabilities) of another NF (other NFs)) from another NF (other NFs). The NEF 111 may store information received as structured data using an interface standardized based on a data storing network function. The stored information may be re-exposed to another NF (other NFs) and an AF(s) by the NEF 111, and may be used for another purpose such as analysis or the like.

The NRF 115 may support a service discovery function. An NF discovery request may be received from an NF instance, and discovered NF instance information may be provided to an NF instance. In addition, available NF instances and services supported by them may be maintained.

For ease of description, although FIG. 1 illustrates a reference model in the case in which the UE 101 accesses the single DN 110 using a single PDU session, the disclosure is not limited thereto.

The UE 101 may simultaneously access two data networks (i.e., a local data network and a central data network) using multiple PDU sessions. In this instance, two SMFs may be selected for different PDU sessions. Each SMF may have a capability of controlling both a local UPF and a central UPF in a PDU session.

In addition, the UE 101, for example, may simultaneously access two data networks (i.e., a local data network and a central data network) provided in a single PDU session.

The NSSF 114 may select a set of network slice instances that serve the UE 101. In addition, the NSSF 114 may determine allowed network slice selection assistance information (NSSAI) and, when needed, may perform mapping of pieces of subscribed single-network slice selection assistance information (S-NSSAIs). In addition, the NSSF 114 may determine configured NSSAI and, when needed, may perform mapping of subscribed S-NSSAIs. In addition, the NSSF 114 may determine an AMF set used for providing a service to a UE, or may determine a list of candidate AMFs by inquiring of the NRF 115 according to a configuration.

The NRF 115 may support a service discovery function. An NF discovery request may be received from an NF instance, and discovered NF instance information may be provided to an NF instance. In addition, available NF instances and services supported by them may be maintained.

In 3GPP systems, conceptual links connecting NFs in the 5G system are defined as reference points. In the following, examples of reference points included in the 5G system architecture described in FIG. 1 are provided below.
N1: a reference point between a UE and an AMF
N2: a reference point between an (R)AN and an AMF
N3: a reference point between an (R)AN and a UPF
N4: a reference point between an SMF and a UPF
N5: a reference point between a PCF and an AF
N6: a reference point between a UPF and a data network
N7: a reference point between an SMF and a PCF
N8: a reference point between a UDM and an AMF
N9: a reference point between two core UPFs
N10: a reference point between a UDM and an SMF
N11: a reference point between an AMF and an SMF
N12: a reference point between an AMF and an AUSF
N13: a reference point between a UDM and an authentication server

function (AUSF)
N14: a reference point between two AMFs
N15: a reference point between a PCF and an AMF for a non-roaming scenario, and a reference point between a PCF and an AMF in a visited network for a roaming scenario

In the following descriptions, a UE may refer to the UE 101, and the terms UE and UE may be used interchangeably. In this case, unless specifically defined additionally, a UE may be understood as the UE 101.

Table 1 given below shows an example of a UE route selection policy (URSP) rule.

TABLE 1
URSP Rules

| | Traffic | | | | | | |
|---|---|---|---|---|---|---|---|
| | Descriptor | | | | | | |
| | (TD) | | Route Selection Component (RSC) | | | | |
| | APPID, DNN, | | | | SSC | PDU- | Access- |
| P | IP, FQDN, CC | P | S-NSSAI | DNN | Mode | Type | Type |
| 1 | App#1 | 1 | S-NSSAI #1 | DNN#1 | SSC#3 | IPv4 | 3GPP |
| 2 | App#2 | 1 | S-NSSAI #2 | DNN#2 | SSC#1 | IPv4/v6 | 3GPP |
| | | 2 | S-NSSAI #2 | DNN#2 | — | — | Non-3GPP |
| 4 | App#1, | 1 | S-NSSAI #1 | DNN#1 | — | — | Non-3GPP |
| | CC = internet, | | | | | | |
| | supl | | | | | | |
| 5 | App#3, | 1 | S-NSSAI #3 | DNN#3 | — | — | Multi-Access |
| | CC = ims | | | | | | |
| 6 | App#1 | 1 | S-NSSAI #1 | DNN#1 | — | — | Multi-Access |
| 7 | * (match all) | 1 | S-NSSAI #4 | DNN#4 | SSC#3 | — | — |

In the 5GC, a PCF may provide policy information to the UE 101, and the URSP may be included in the UE policy information

The URSP may be used by the UE 101, and may be used to determine whether an application detected by the UE 101 is capable of being associated with a PDU session that has already been established, is capable of being offloaded to a non-3GPP access existing outside the PDU session, or is capable of being routed via a ProSe Layer-3 UE-to-Network relay existing outside the PDU session, or whether a new PDU session is capable of being established and associated with the application, or the like. The URSP may include one or more URSP rules, and a single traffic descriptor and one or more route selection components (RSC) may be included in a single URSP rule.

A traffic descriptor (TD) may include matching criteria for identifying application detected by the UE 101 or traffic of the application. Detailed examples are as follows.

Application descriptor: information indicating an application of the UE 101. For example, the application descriptor may include an APPID configured with an OSID and an OSAPPID.

IP descriptor: shows an IP address indicating a destination address of an IP packet transmitted by the UE 101. The IP descriptor may include an IP 3-tuple, i.e., an IP destination address, a port number, and a protocol.

Domain descriptor: expresses a destination address of a server that the UE 101 connects to, for example, in a fully qualified domain name (FQDN) form.

Non-IP descriptor: information designating a reception point of non-IP data.

DNN: a data network name.

Connection Capability (CC): corresponds to type information designating a characteristic of connected traffic, and has a value such as an IP multimedia subsystem (IMS), a multimedia message service (MMS), the Internet, or the like.

A route selection component (RSC) may include property information of a PDU session for determining a PDU session to be connected to an application or application traffic when a traffic descriptor capable of identifying an application detected by the UE 101 is specified. Detailed examples are as follows.

SSC Mode Selection: has a value such as SSC Mode 1, SSC Mode 2, SSC Mode 3, or the like as an element for designating session and service continuity.

Network Slice Selection: information for designating a network slice.

DNN Selection: a data network name.

PDU Session Type Selection: an element for designating a PDU-session type that designates IPv4, IPv6 or IPv4v6, or Ethernet, Non-IP

Non-Seamless Offload indication: indicates that offloading of traffic of an application is allowed via a non-3GPP access existing outside a PDU session.

ProSe (Proximity-services) Layer-3 UE-to-Network Relay Offload indication: indicates that offloading of traffic of an application is allowed via a ProSe Layer-3 UE-to-network relay existing outside a PDU session.

Access Type preference: an element indicating whether a PDU session is a PDU session connected via 3GPP access, a session connected via non-3GPP access, or a session that supports a multi-access connection that uses both the 3GPP access and the non-3GPP access.

PDU Session Pair ID: an element indicating an identifier of a redundant PDU session in which application traffic is shared.

RSN (Redundancy Sequence Number): an element indicating an identifier used for redundant transmission.

A plurality of URSP rules may be distributed in policy sections (PSs) of a UE policy container. In an embodiment of the disclosure, a plurality of URSP rules may be distributed in a plurality of policy sections under the condition that the magnitude does not exceed a maximum transmission size allowed by a non-access-stratum (NAS). A single URSP rule may not be spread out into two PSs. A single intact URSP rule may be included in one policy section.

A USRP rule may have a priority order for each rule. According to an embodiment of the disclosure, each URSP rule may include a URSP rule identifier for identifying a URSP rule. Specifically, an URSP rule identifier may be a traffic parameter that enables the UE 101 to identify a UE application.

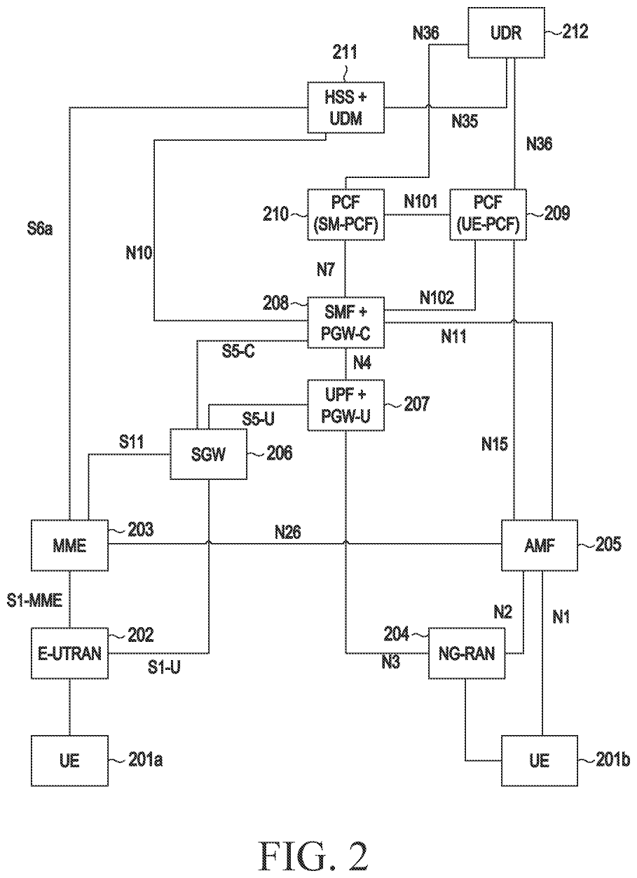

FIG. 2 is a diagram illustrating an example of a network structure and interfaces of a wireless communication system that supports interworking between the EPS and the 5GS according to an embodiment of the disclosure. For basic functions of corresponding entities in FIG. 1 among the network entities in FIG. 2, refer to the descriptions provided with reference to FIG. 1.

The 5GS may include a New Radio (NR) base station (NG-radio access node (NG-RAN) or next generation node B (gNB)) 204 for radio access of a user equipment (UE) 201b, and an access and mobility management function (AMF) 205, and, although not illustrated in FIG. 2, may additionally include a session management function (SMF), a user plane function (UPF), a policy control function (PCF), a network slice selection function (NSSF), a unified data management (UDM), a unified data repository (UDR), or the like, described in FIG. 1.

An EPS may include an E-UTRA base station 202 (Evolved Universal Mobile Telecommunications System (UMTS) Terrestrial Radio Access Network (E-UTRAN), or evolved node B (eNB)) for radio access of a UE 201a, a mobility management entity (MME) 203 for managing mobility of the UE 201a, a serving gateway (SGW) 206 that is in charge of a user plane of the UE 201a, a packet data network gateway (PGW) (PGW may be configured with a PGW-U (user) and a PGW-C (control)), a policy and charging rule function (PCRF) for managing policy information, and a home subscriber server (HSS) for managing subscriber information of the UE 201a, or the like.

According to an embodiment, the AMF and MME may be a network function (NF) that manages radio network access and mobility for a UE. The SMF, SGW, and PGW may be NFs for session management for a UE, and session information may include quality of service (QoS) information, charging information, and packet processing information. In addition, the UPF and PGW may be NFs for processing user plane traffic, and may be controlled by the SMF and SGW. The PCF and PCRF may be NFs for managing an operator policy and/or PLMN policy for providing a communication service in a wireless communication system. In addition, the PCF may be divided as a PCF (i.e., UE-PCF) that is in charge of an access and mobility (AM) policy and a UE policy, and a PCF (i.e., SM-PCF) that is in charge of session management (SM). The PCF in charge of the AM/UM policy (i.e., AM-PCF/UE-PCF) and the PCF in charge of the SM policy (i.e., SM-PCF) may be logically or physically separated NFs or logically or physically single NF. The UDM and HSS may be NFs for storing and managing UE subscription information. The UDR may be an NF or database (DB) for storing and managing data. The UDR 212 may store UE subscription information and may provide UE subscription information to the UDM. In addition, the UDR 212 may store operator policy information, and may provide the operator policy information to the PCF. The NSSF may be an NF that performs a function of selecting network slice instances that provide services to a UE, or a function of determining network slice selection assistance information (NSSAI).

The instance may be the state in which an NF is in the form of software code, and is executable since it is assigned with physical and/or logical resources from a computing system in order to perform the function of the NF in a physical computing system (e.g., a predetermined computing system existing in a core network). For example, an AMF instance, an SMF instance, an NSSF instance, or the like may be the state of being assigned with physical and/or logical resources for an AMF operation, an SMF operation, an NSSF operation, or the like, respectively, from a predetermined computing system existing in the core network, and capable of using the resources. Accordingly, the AMF instance, SMF instance, or NSSF instance that are assigned with physical and/or logical resources for AMF, SMF, and NSSF operations from the predetermined computing system existing in the network may perform the same operations as the case when a physical AMF, SMF, and NSSF devices exist.

The UDM of the 5GS and the HSS of the EPS may be configured as a combo node 211 (or referred to as a combination node) (referred to as a UDM+HSS) (or referred to as an HSS+UDM). The UDM+HSS node 211 may store UE subscription information. The SMF of the 5GS and the PGW-C of the EPS may be configured as a single combo node 208 (referred to as a SMF+PGW-C) (or referred to as a PGW-C+SMF). The PCF of the 5GS and the policy control and charging rules function (PCRF) of the EPS may be configured as a single combo node (referred to as a PCF+PCRF) (or referred to as a PCRF+PCF). The UPF of the 5GS and the PGW-U of the EPS may be configured as a single combo node 207 (referred to as a UPF+PGW-U) (or referred to as a PGW-U+UPF). The UE 201a may access the MME 203 of the EPS via the E-UTRA base station 202, and may use an EPS network service. In addition, the UE 201b may access the AMF 205 of the 5GS via the NR base station 204, and may use a 5GS network service. Although different reference numerals are used for a UE that accesses the EPS and a UE that accesses the 5GS in FIG. 2, the UEs 201a and 201b may be the same UE. This is to indicate that the UE is a UE capable of accessing the EPS and also capable of accessing the 5GS.

In addition, in the disclosure, the EPS and the 5GS may be referred to as a first network and a second network, or may be referred to as a second network and a first network.

As described above, one NF or network entity may simultaneously support different network systems, and the NF, network node, or network entity may be referred to as a combo node, a combo NF, a combined node, a combined NF, an interworking node, an interworking NF, or the like as described above. In addition, the functions of the NF described as the combo node may be implemented via interworking between two or more network entities. In addition, for ease of description, an NF that simultaneously supports different network systems may be expressed using symbols “+” or “/.” For example, when an SMF and a PGW-C are configured as a single combo node, it may be expressed as a PGW-C/SMF, PGW-C+SMF, SMF/PGW-C, or SMF+PGW-C.

The UE 201a or 201b may access a data network (e.g., IP network providing an Internet service) via the 5GS or EPS, and may establish a session. In this instance, the UE may identify each data network by using an identifier called a data network name (DNN) or an access point name (APN). To identify a data network, a DNN may be used in the 5GS and an APN may be used in the EPS. The DNN and the APN may be used to determine an NF related to a user plane, an interface between NFs, an operator policy, or the like, when a UE connects a session with a network system. The DNN and the APN may be understood as equivalent information, and may transfer the same information. The DNN, for example, may be used for selecting an SMF and UPF(s) for a PDU session, and may be used for selecting an interface(s) (e.g., N6 interface) between a data network and a UPF for a PDU session. In addition, the DNN may be used for determining a policy of a mobile communication operator to be applied to a PDU session.

In the following embodiments, a combo node such as a UDM+HSS node, PCF+PCRF node, SMF+PGW-C node, UPF+PGW-C node, or the like will be mentioned without “node.” In the following embodiments, a definition of a message defined in one embodiment may be applied as the same meaning in other embodiments that use the same message.

The PCF may be divided as a session management-policy control (SM-PCF) 210 that is in charge of a session management policy (SM policy) and a UE-policy control function (UE-PCF) 209 that is in charge of a mobility management policy (AM policy) and/or UE policy. The SM-PCF 210 may be connected to the SMF (SMF+PGW-C in FIG. 2) 208 via an N7 interface, and may not be connected to the AMF 205. In other words, the SM-PCF 210 may not support an N15 interface. The UE-PCF 209 may be connected to the AMF 205 via the N15 interface, and may not be connected to the SMF (SMF+PGW-C in FIG. 2) 208. In other words, the UE-PCF 209 may not support the N7 interface. The SM-PCF 210 and the UE-PCF 209 may be located in physically and/or logically one device or PCF, but may be distinguished as different PCF instances.

In a UE policy that the PCF provides to a UE may include an access network discovery & selection policy, a UE route selection policy, a vehicle-to-everything (V2X) policy, and/or a ProSe policy.

Access Network Discovery & Selection Policy (ANDSP): includes policy information needed when a UE selects a non-3GPP access network.

UE Route Selection Policy (URSP): includes policy information needed for routing traffic that goes out from a UE.

V2X Policy (V2XP): includes policy information providing a configuration parameter needed when a UE performs V2X communication.

ProSe Policy (ProSeP): includes policy information providing a configuration parameter needed when a UE performs ProSe direct discovery, ProSe direct communication, and ProSe UE-to-network relay and remote UE communication.

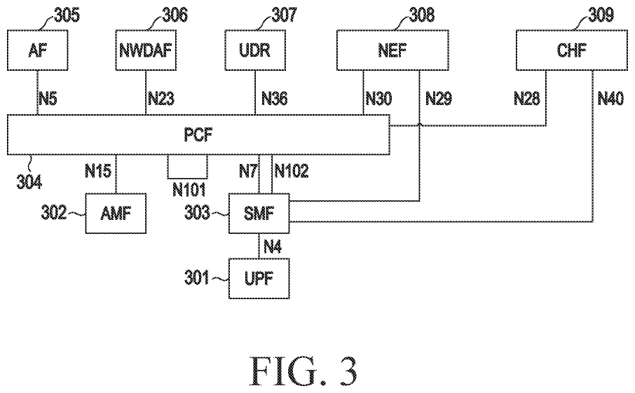

FIG. 3 is a diagram illustrating a network structure and interfaces in association with a policy control and charging control system of the 5G system according to an embodiment of the disclosure. For basic functions of corresponding entities in FIGS. 1 and 2 among the network entities in FIG. 3, refer to the descriptions provided with reference to FIGS. 1 and 2.

A policy control function (PCF) 304 may perform a role of a unified control framework that controls a network operation.

An application function (AF) 305 may provide session related information to a charging function in order to support generating rules.

A network data analytics function (NWDAF) 306 may collect data from an NF included in a core network. In this instance, the NWDAF 306 and a counterpart NF may need to belong to the same public land mobile network (PLMN).

A unified data repository (UDR) 307 may provide subscriber information data (subscription data), policy data, structured data for exposure, and application data to a UDM (not illustrated), the PCF 304, an NEF 308, or the like.

The network exposure function (NEF) 308 may perform a role of safely exposing a network service and function.

A charging function (CHF) 309 may communicate with a 5G core network and may provide a charging system related to network resource usage.

A single PCF instance may not simultaneously support N15 and N7.

N15: a reference point between an AMF 302 and the PCF 304.

N7: a reference point between an SMF 303 and the PCF 304.

N4: a reference point between the SMF 303 and a UPF 301.

N5: a reference point between the AF 305 and the PCF 304.

N23: a reference point between the NWDAF 306 and the PCF 304.

N36: a reference point between the UDR 307 and the PCF 304.

N30: a reference point between the NEF 308 and the PCF 304.

N29: a reference point between the NEF 302 and the SMF 303.

N28: a reference point between the CHF 309 and the PCF 304.

N40: a reference point between the CHF 309 and the SMF 303.

N101: a reference point between a PCF instance supporting N15 and a PCF instance supporting N7.

N102: a reference point between a PCF supporting N15 and an SMF.

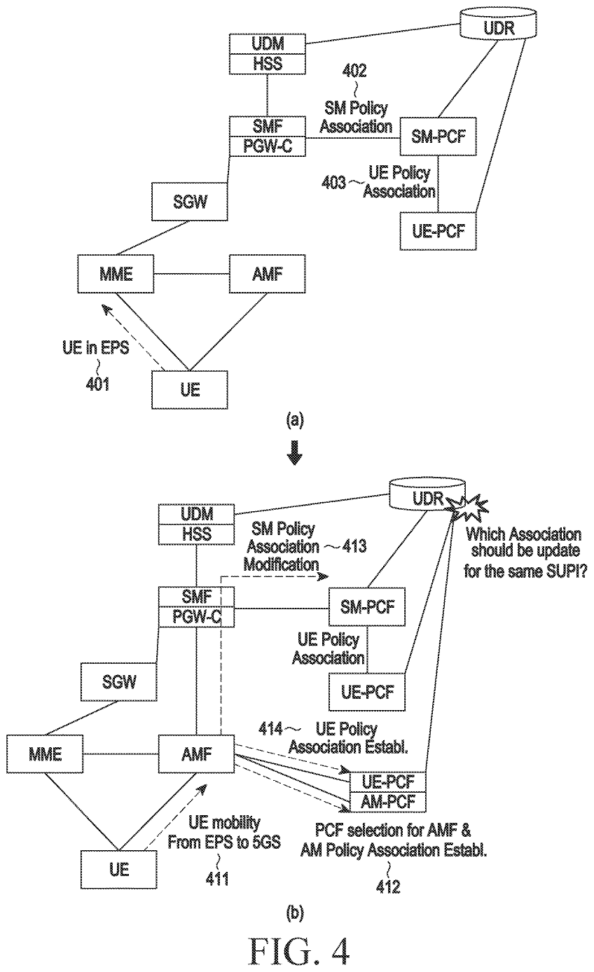

FIG. 4 a diagram illustrating a network access procedure in a wireless communication system that supports interworking between the EPS and the 5GS that support UE policy management according to an embodiment of the disclosure.

Part (a) of FIG. 4 illustrates a procedure and system structure in which a UE accesses a core network via an EPS entity (i.e., a network entity in the EPS), and part (b) of FIG. 4 illustrates a procedure and system structure in which a UE moves core network access from the EPS to the 5GS.

The system structure illustrated in FIG. 4 is basically based on the structure of a wireless communication system that supports interworking between the EPS and the 5GS as illustrated in FIG. 2. For a portion that is not illustrated or described in FIG. 4, refer to the drawing and the description of FIG. 2.

It is not that all the described operations are necessarily included and some operation(s) may be omitted depending on a configuration and/or definition or the like in the system.

Referring to part (a) of FIG. 4, a procedure and system structure in which a UE accesses a core network via an EPS entity in a wireless communication system that supports interworking between the EPS and the 5GS that support UE policy management will be described in detail.

In operation 401, the UE may access a core network via an MME.

In operations 402 and 403, when the UE and/or core network are capable of transmitting/receiving a UE management policy to the UE via an EPS entity, an SMF+PGW-C may request a UE-PCF to perform a procedure of establishing and managing a UE policy association via an SM-PCF by using an SM policy association established with the SM-PCF.

Referring to part (b) of FIG. 4, a procedure and system structure in which a UE moves core network access from the EPS to the 5GS in a wireless communication system that supports interworking between the EPS and the 5GS that support UE policy management will be described in detail.

In operation 411, the UE may access a core network of the 5GS via an AMF.

In operation 412, in a 5GS registration procedure of UE, the AMF may perform PCF selection for the AMF in order to manage an access management policy (AM policy), and the selected PCF, as an AM-PCF, may establish an AM policy association with the AMF. Here, the AM-PCF may be the same PCF as the UE-PCF with which the AMF establishes a UE policy association in order to transmit/receive UE policy information. Here, the same PCF may be a PCF identified by the same PCF ID and/or the same PCF instance ID.

In operation 413, in the 5G registration procedure of UE, when the AMF recognizes that the UE accessed the core network via the EPS and has moved to the 5GS, the AMF may request a session modification procedure (PDU session modification) from the SMF+PGW-C that managed a session (e.g., PDN connection) used by the UE in the EPS. The SMF+PGW-C may obtain information related to a UE management policy association (UE policy association) from a UE-PCF via an SM-PCF by using a session management policy association modification procedure (SM policy association modification), and may transfer the same to the AMF.

In operation 414, in the 5GS registration procedure of UE, after notifying, to the UE, that a registration request of the UE is accepted, the AMF may establish a UE policy association with the UE-PCF in order to transmit/receive UE policy information for the UE as described in operation 412. When the AM-PCF and UE-PCF (referred to as PCF #1) selected as a PCF for the AMF in operation 412 are different from the UE-PCF (referred to as PCF #2, and corresponding to the UE-PCF in operation 413) that managed the UE policy when the UE accessed via EPS, a UDR may be notified of information related to a UE policy from one or more PCFs that are in charge of UE policy management for the same UE. Here, the same UE may be a UE identified by the same subscription permanent identifier (SUPI). When a change (including generation, modification, deletion) occurs in the UE management policy of the UE, the UDR may determine a PCF to be notified of the change from among the one or more PCFs. In addition, when the UE management policy is not normally transferred to the UE, the UDR may determine which PCF corresponds to a PCF in charge of follow-up management from among the one or more PCFs. In addition, the UDR may need to determine from which PCF a UE management policy with a higher priority order is received, from among the one or more PCFs.

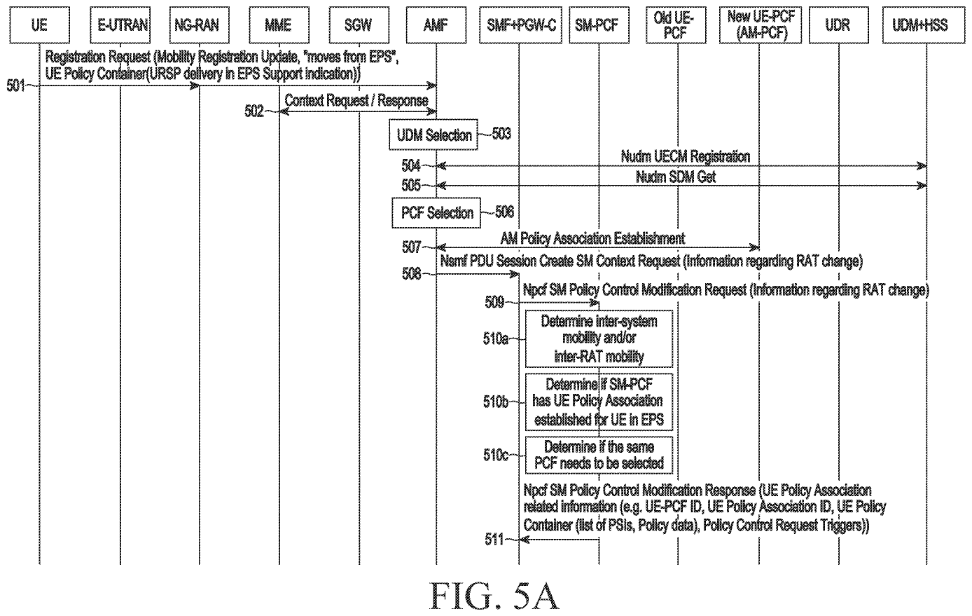

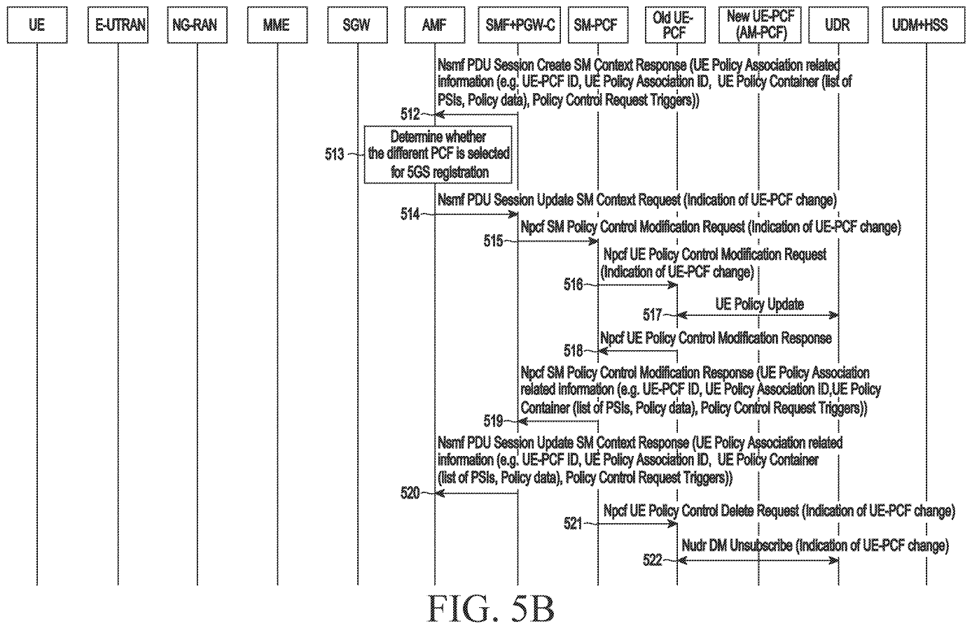

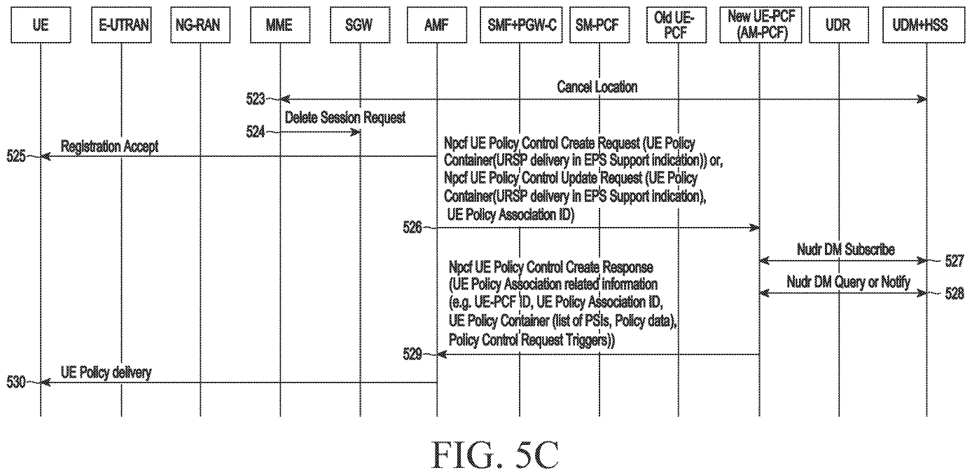

Hereinafter, with reference to embodiments of FIGS. 5A to 5C, 6A to 6C, and 7A to 7C, for example, when a UE moves from the EPS to the 5GS, a method of selecting one PCF that is in charge of UE policy management will be described. In the embodiments of FIGS. 5A to 5C, 6A to 6C, and 7A to 7C, for the basic functions of network entities, refer to the descriptions of entities corresponding to FIGS. 1 to 4 mentioned above. In addition, in the embodiments of the disclosure, a PCF used for an EPS access of UE is referred to as an old UE-PCF (or old AM-PCF/UE-PCF), and a PCF selected after the UE moves from the EPS to the 5GS is referred to as a new UE-PCF (or new AM-PCF/UE-PCF). In the disclosure, an SM-PCF, the old UE-PCF (or old AM-PCF/UE-PCF), and the new UE-PCF (or new AM-PCF/UE-PCF) may be referred to as a first PCF, a second PCF, and a third PCF, or other various names may be used for distinguishing the SM-PCF, old UE-PCF, and the new UE-PCF. In addition, the PCF used for the EPS access of UE may be referred to as a PCRF as described in FIG. 2.

FIGS. 5A to 5C are diagrams illustrating a procedure of managing a UE policy association during a process in which a UE moves core network access from the EPS to the 5GS in a wireless communication system that supports interworking between the EPS and the 5GS, according to an embodiment of the disclosure. More particularly, FIG. 5 is a diagram illustrating a procedure in which a PCF that is different from a PCF used for an EPS access of UE manages a UE policy association when the UE accesses via the 5GS.

Referring to FIG. 5A, in operation 501, the UE may transmit a registration request message to an AMF via an NG-RAN. The registration request message in operation 501 may include at least one from among (1) a registration type indicating mobility registration update, (2) handover (or mobility) related information indicating that the UE has moved from the EPS, and (3) a UE policy container including UE policy related information stored in the UE. The UE policy related information included in the UE policy container may include an indicator (e.g., URSP delivery in EPS support indication) indicating that the UE is capable of transmitting/receiving UE policy information via an EPS entity.

In operation 502, the AMF may request UE related information (context) from an MME. In response to the request, the MME may provide the UE related information to the AMF.

In operation 503, the AMF may select a UDM (or UDM+HSS).

In operation 504, as an NF in charge of UE access and registration management, the AMF may perform UE context management (UECM) registration with the UDM (or UDM+HSS).

In operation 505, the AMF may obtain the subscription data of UE from the UDM (or UDM+HSS) via subscriber data management (SDM) get.

In operation 506, the AMF may select a PCF for the AMF (i.e., a PCF in charge of an AM policy and a UE policy, a PCF for AMF) (i.e., new AM-PCF/UE-PCF in FIG. 5A).

In operation 507, the AMF may perform an AM policy association establishment procedure with respect to the new PCF (new AM-PCF/UE-PCF) selected in operation 506.

In operation 508, the AMF may transmit, to an SMF+PGW-C, a request message that requests generating a PDU session. The request message in operation 508 may include information (i.e., information related to a change of an RAT) indicating that the type of radio access technology (RAT) that the UE accesses is changed. For example, a method of providing an NR as an RAT type that the UE accesses or providing both Evolved-Universal Terrestrial Radio Access Network (E-UTRAN) which is a previous RAT type that the UE accessed via the EPS, and NR which is the current RAT type that the UE accesses via the 5GS, may be used.

In operation 509, the SMF+PGW-C may transmit, to an SM-PCF, a request message that requests modifying an SM policy in association with a PDN connection corresponding to a PDU session to be generated. The request message in operation 509 may include information (i.e., information related to a change of an RAT) indicating that the type of radio access technology (RAT) that the UE accesses is changed. In this instance, the information related to the change of the RAT may include a portion or the whole of the information received from the AMF in operation 508, or may include information provided from the SMF+PGW-C although the information related to the change of the RAT is not received from the AMF. When the SMF+PGW-C does not receive the information related to the change of the RAT from the AMF, the SMF+PGW-C or another NF or an arbitrary network entity may perform determination and transfer, to the SM-PCF, corresponding information in association with the change of the RAT.

In operations 510a, 510b, and 510c, the SM-PCF may determine whether a new PCF is capable of being used in the 5GS, or the PCF used in the EPS needs to be continuously used. Some or all of operations 510a, 510b, and 510c may be performed sequentially/selectively, or in parallel.

In operation 510a, the SM-PCF may determine whether the movement of the UE is inter-system movement (inter-system mobility). In other words, the SM-PCF may determine that the UE has moved from the EPS to the 5GS. Alternatively, the SM-PCF may determine whether the movement of the UE is inter-RAT movement (inter-RAT mobility). In other words, it is determined that the UE has moved from an EPS RAT (e.g., E-UTRAN) to a 5GS RAT (e.g., NR).

In operation 510b, the SM-PCF may determine whether a UE policy association established for the UE that accessed the EPS exists.

In operation 510c, the SM-PCF may determine whether the same PCF as the PCF used in the EPS is capable of being used when the UE moves from the EPS to the 5GS. In the embodiment, it is assumed that different PCFs are used.

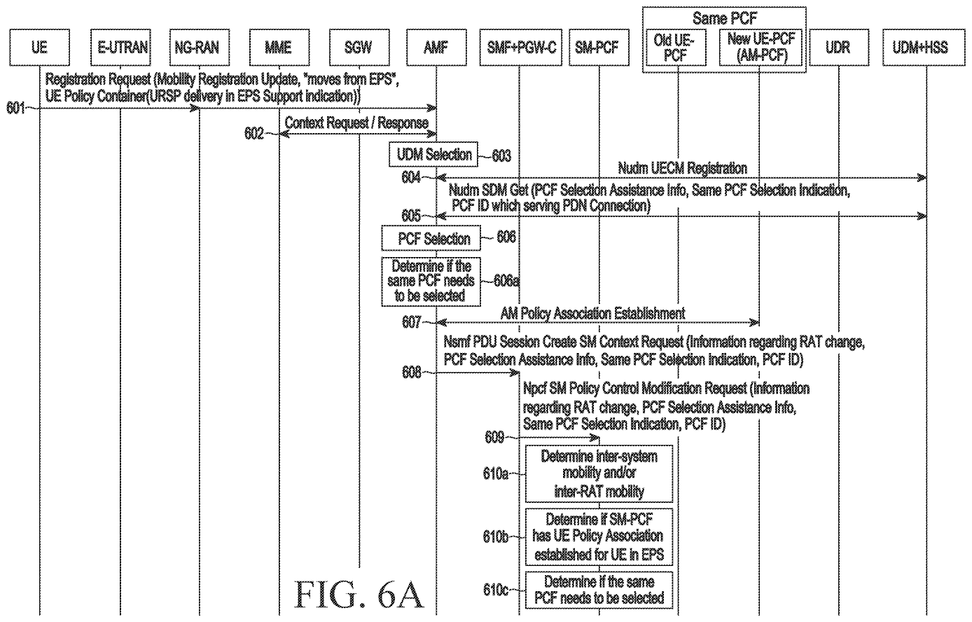

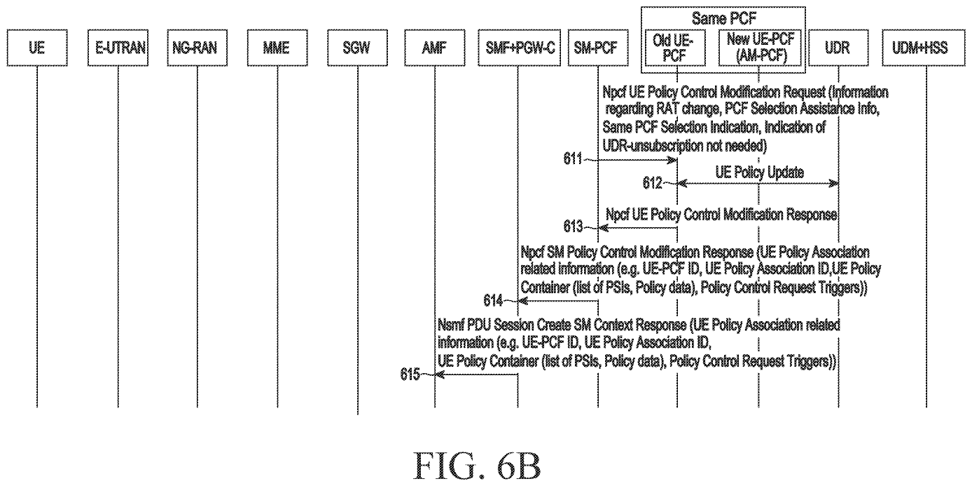

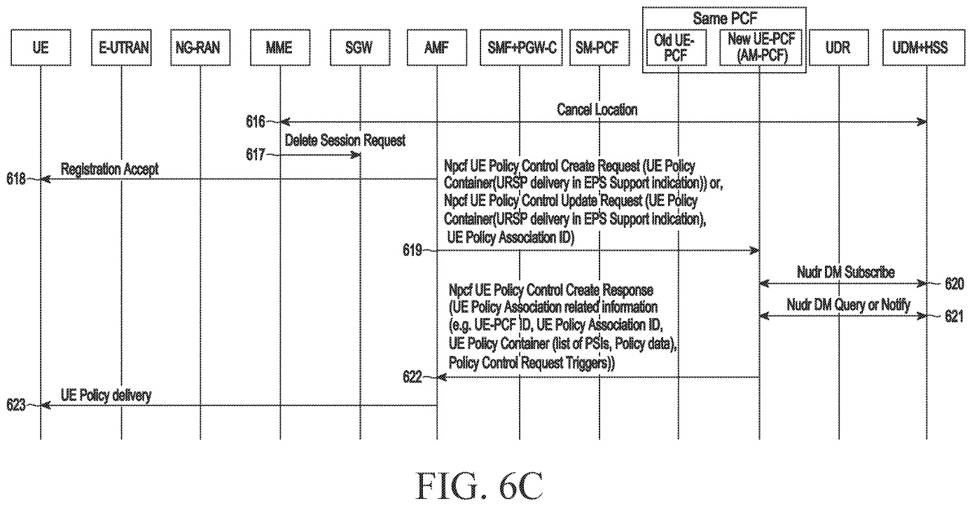

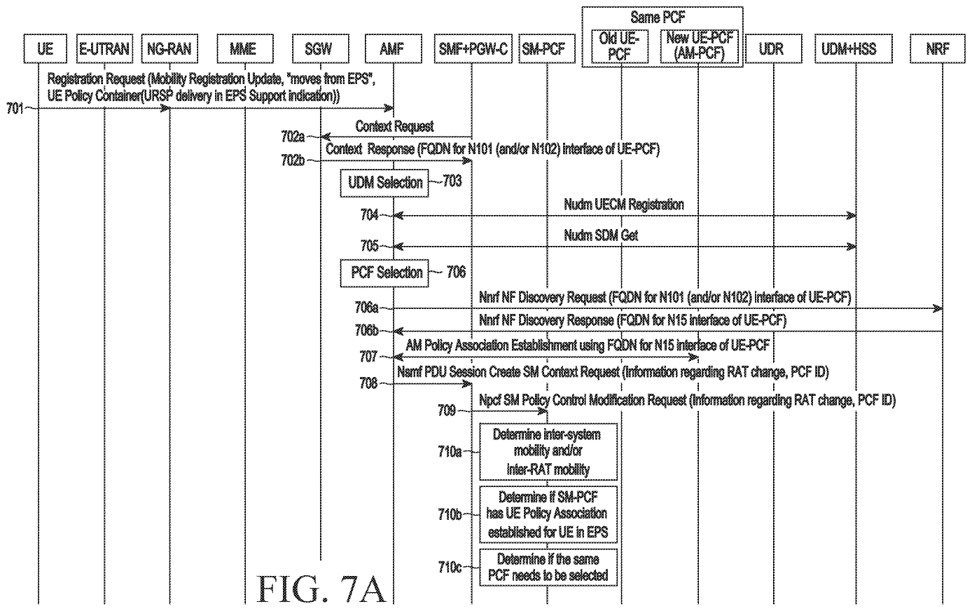

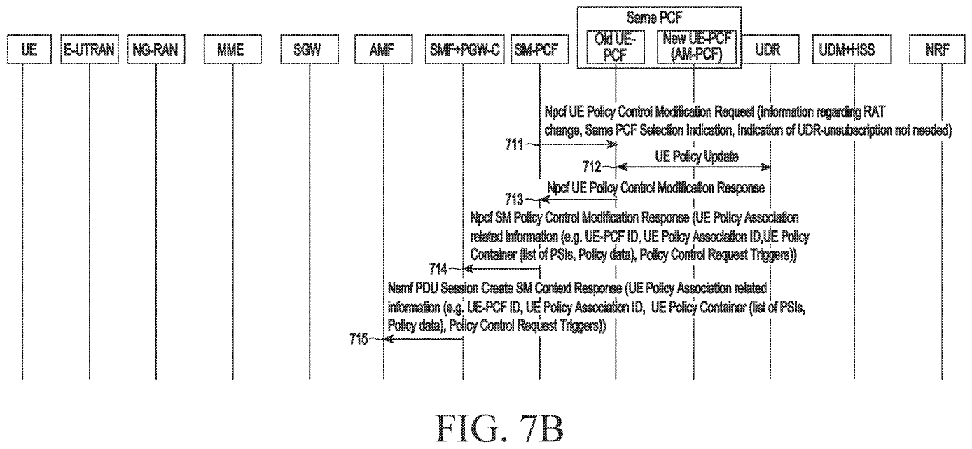

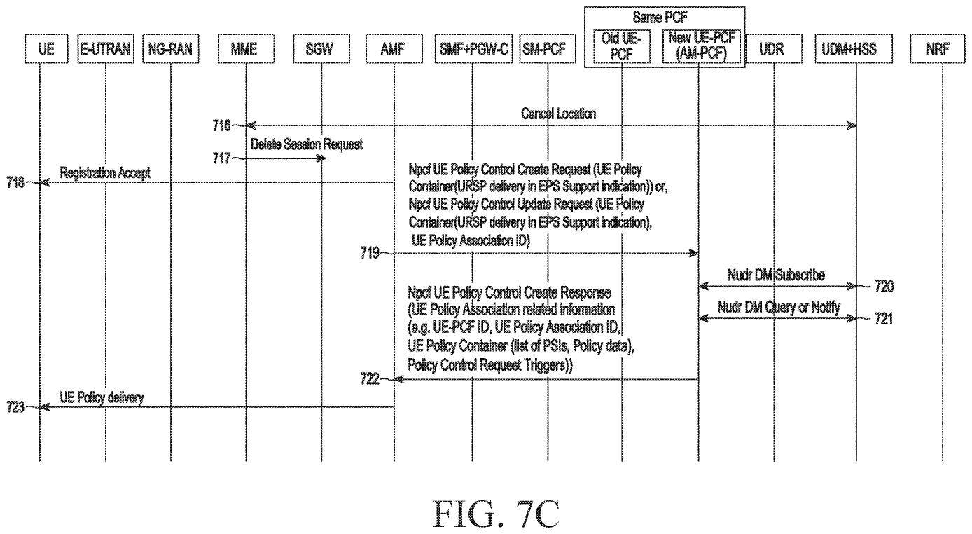

In operation 511, based on the determination results of operations 510a, 510b, and 510c, the SM-PCF may transmit a response message to the SM+PGW-C in response to the SM policy modification request. Hereinafter, a description is provided on the assumption that the SM-PCF determines that a new PCF (i.e., a different PCF) is to be used in the 5GS in operations 510a, 510b, and 510c. Operation performed when it is determined that the PCF used in the EPS is to be continuously used will be described with reference to embodiments of FIGS. 6A to 6C and embodiments of FIGS. 7A to 7C. The response message in operation 511 may include UE policy association related information. The UE policy association related information may include at least one from among (1) an identifier of a UE-PCF used in the EPS, (2) an identifier of a UE policy association established in the EPS, (3) UE policy information stored in the SM-PCF, and (4) a policy control request trigger stored in the SM-PCF, in association with the corresponding UE. The information (3) and (4) may be information that the SM-PCF obtains by immediately requesting from the UE-PCF in order to provide the same to the SM+PGW-C. The UE policy information corresponding to the information (3) may include a policy section identifier (PSI) list and/or UE policy data, which may be provided in the form of a UE policy container.

Referring to FIG. 5B, in operation 512, the SMF+PGW-C may transmit, to the AMF, a response message to the PDU session establishment request of operation 508. The response message in operation 512 may include UE policy association related information. The UE policy association related information may include at least one from among (1) the identifier of the UE-PCF used in the EPS, (2) the identifier of the UE policy association established in the EPS, (3) the UE policy information stored in the SM-PCF, and (4) the policy control request trigger stored in the SM-PCF. The UE policy information corresponding to the information (3) may include the policy section identifier (PSI) list and/or UE policy data, which may be provided in the form of a UE policy container. The UE policy association related information may include at least one from among the information that the SMF+PGW-C receives from the SM-PCF in operation 511 and may include information received from the corresponding UE-PCF when the SMF+PGW-C has a direct association with the UE-PCF.

In operation 513, the AMF may determine whether a new PCF is capable of being selected in the 5GS.

When it is determined that the new PCF is capable of being selected in the 5GS in operation 513, the AMF may transmit, to the SMF+PGW-C, a request message that requests PDU session update in operation 514. The request message in operation 514 may include an indicator (indication of UE-PCF change) indicating that a new PCF (e.g., UE-PCF) is selected in the 5GS. For example, when the UE policy related information received in operation 512 includes the identifier of the UE-PCF used in the EPS, the AMF may compare the identifier of the UE-PCF with an identifier of the PCF selected in operation 506 and, when it is determined that they are different PCFs, may include an indicator indicating that a new PCF is selected in the request message.

In operation 515, the SMF+PGW-C may transmit, to the SM-PCF, a request message that requests SM policy modification. The request message in operation 515 may include an indicator indicating that a new PCF is selected.

In operation 516, the SM-PCF may transmit a request message that requests UE policy modification to the old UE-PCF that used in the EPS. The request message in operation 516 may include an indicator indicating that a new PCF is selected. As a selective embodiment, when it is determined that a new PCF is capable of being used in the 5GS in operation 510, the SM-PCF may omit operations 511 to 515, and may immediately perform operation 516. In this instance, although the indicator indicating that a new PCF is selected is not received from the AMF and/or SMF+PGW-C, the SM-PCF may perform determination and provide, to the UE-PCF, an indicator indicating that a new PCF is selected.

In operation 517, the old UE-PCF may obtain a latest UE policy from the UDR via UE policy update, or may provide the latest UE policy to the UDR.

In operation 518, the old UE-PCF may provide the latest UE policy to the SM-PCF and may respond to the UE policy modification request of operation 516.

In operation 519, the SM-PCF may transmit, to the SM+PGW-C, a response message to the SM policy modification request of operation 515. The response message in operation 519 may include UE policy association related information. The UE policy association related information may include at least one from among (1) the identifier of the UE-PCF used in the EPS, (2) the identifier of the UE policy association established in the EPS, (3) the UE policy information stored in the SM-PCF, and (4) the policy control request trigger stored in the SM-PCF. The UE policy information corresponding to information (3) may include the policy section identifier (PSI) list and/or UE policy data, which may be provided in the form of a UE policy container.

In operation 520, the SMF+PGW-C may transmit, to the AMF, a response message to the PDU session update request of operation 514. The response message in operation 520 may include UE policy association related information. The UE policy association related information may include at least one from among (1) the identifier of the UE-PCF used in the EPS, (2) the identifier of the UE policy association established in the EPS, (3) the UE policy information stored in the SM-PCF, and (4) the policy control request trigger stored in the SM-PCF. The UE policy information corresponding to the information (3) may include the policy section identifier (PSI) list and/or UE policy data, which may be provided in the form of a UE policy container.

In operation 521, the SM-PCF may transmit, to the old UE-PCF, a request message that requests deletion (delete, termination) of the UE policy association between the SM-PCF and the old UE-PCF. The request message in operation 521 may include an indicator indicating that a new PCF is selected. The SM-PCF may request the old UE-PCF to delete the UE policy association but to maintain the UE policy data stored in the UDR, and this request may be expressed by using an indicator indicating that a new PCF is selected and/or a separate indicator.

In operation 522, the old UE-PCF may transmit, to the UDR, a request message that requests unsubscribing from UE policy data-related subscription. The request message in operation 522 may include an indicator indicating that a new PCF is selected. The UE-PCF may request the old UE-PCF to perform unsubscribing from UE policy data-related subscription but to maintain the UE policy data stored in the UDR, and this request may be expressed by using an indicator indicating that a new PCF is selected and/or a separate indicator.

Referring to FIG. 5C, in operation 523, the registration of MME with the UDM-HSS may be cancelled.

In operation 524, the MME may request deleting a session from the SGW of the EPS.

In operation 525, when the registration request of UE with the 5GS in operation 501 is accepted, the AMF may transmit an acceptance message to the UE.

In operation 526, the AMF may transmit a request message that requests establishing or modifying a UE policy association to a new UE-PCF that is newly selected. The request message in operation 526 may include at least one of (1) UE policy related information when the UE provides the same to the AMF in operation 501 and (2) a UE policy association identifier. The UE policy related information corresponding to the information (1) may include an indicator indicating that the UE is capable of transmitting/receiving a UE policy via an EPS entity, and this indicator may be included in a UE policy container and may be provided. The UE policy related information corresponding to the information (1) may include information that the AMF receives in operation 512 and/or operation 520, and the information may be taken into consideration together when the new UE-PCF determines a latest UE policy for the UE in operations 528 and 529.

In operation 527, the new UE-PCF may request, from the UDR, UE policy data related subscription.

In operation 528, the new UE-PCF may request and obtain (query) latest UE policy data from the UDR, or the UDR may provide (notify) the latest UE policy data to the new UE-PCF, or the new UE-PCF may determine a UE policy for the UE and provide the same to the UDR.

In operation 529, the new UE-PCF may transmit, to the AMF, a response message to the UE policy association establishment/modification request. The response message in operation 529 may include UE policy association related information. The UE policy association related information may include at least one from among (1) an identifier of the new UE-PCF, (2) an identifier of the UE policy association established between the new UE-PCF and the AMF, (3) UE policy information, and (4) a policy control request trigger. The UE policy information corresponding to information (3) may include a policy section identifier (PSI) list and/or UE policy data, which may be provided in the form of a UE policy container.

In operation 530, the AMF may provide the UE policy information to the UE. This process may be performed via a UE configuration update procedure.

FIGS. 6A to 6C are diagrams illustrating a procedure of managing a UE policy association during a process in which a UE moves core network access from the EPS to the 5GS in a wireless communication system that supports interworking between the EPS and the 5GS according to an embodiment of the disclosure. More specifically, FIGS. 6A to 6C illustrate a procedure in which a PCF used for an EPS access of UE also manages a UE policy association in the 5GS by using an identifier of the PCF used in the EPS access of UE, when the UE accesses the 5GS.

Referring to FIG. 6A, in operation 601, the UE may transmit a registration request message to an AMF via an NG-RAN. The registration request message in operation 601 may include at least one from among (1) a registration type indicating mobility registration update, (2) handover (or mobility) related information indicating that the UE has moved from the EPS, and (3) a UE policy container including UE policy related information stored in the UE. The UE policy related information included in the UE policy container may include an indicator (e.g., URSP delivery in EPS support indication) indicating that the UE is capable of transmitting/receiving a UE policy via an EPS entity.

In operation 602, the AMF may request, from an MME, information (context) related to the UE. In response to the request, the MME may provide the UE related information (context) to the AMF.

In operation 603, the AMF may select a UDM (or UDM+HSS).

In operation 604, as an NF in charge of UE access and registration management, the AMF may perform UECM registration with the UDM (or UDM+HSS).

In operation 605, the AMF may obtain subscription data of the UE from the UDM (or UDM+HSS). The information that the AMF receives from the UDM may include at least one from among PCF selection assistance information and/or an identifier (PCF ID which serving PDN connection) of the PCF that managed a PDN connection associated with the UE in the EPS before operation 601. The PCF selection assistance information may be configured as a list of DNN and S-NSSAI combination(s) allowing that a PCF for access management policy control and a PCF for session management policy control are the same PCF, as shown in Table 2 below. Table 2 given below is an example of UE subscription data types.

TABLE 2

| Subscription data | | |
|---|---|---|
| type | Field | Description |
| Access and | PCF | list of combination of DNN and S- |
| Mobility | Selection | NSSAI that indicates that the same PCF |
| Subscription data | Assistance | needs to be selected for AM Policy |
| (data needed for | info | Control and SM Policy Control (NOTE |
| UE Registration | | 10). |
| and Mobility | | |
| Management) | | |

(NOTE 10):
The same PCF can be selected to serve the UE and to serve one or multiple PDU sessions, each of them is indicated in the list of S-NSSAI, DNN combinations in the PCF Selection Assistance Info. Providing one combination of DNN and S-NSSAI in the PCF Selection Assistance Info is assumed if interworking with EPS is needed. In case multiple PDU sessions to one DNN, S-NSSAI are established in EPS, it is appropriate to select same PCF by configuration or by using existing method, e.g. same PCF selection in usage monitoring.

In operation 606, the AMF may select a PCF for the AMF (i.e., a PCF in charge of an AM policy and a UE policy, a PCF for AMF) (i.e., new AM-PCF/UE-PCF in FIG. 6A).

The operation 606 may include operation 606a, and the AMF selects a PCF in operation 606a by referring to the information received from the UDM in operation 605. For example, when the S-NSSAI and DNN combination supported by the PDN connection that the UE is to move from the EPS to the 5GS is included in the PCF selection assistance info received in operation 605, the AMF may select, again, the PCF that managed the session management policy control of the corresponding PDN connection. In this instance, when an identifier of the PCF that managed the PDN connection of the UE in the EPS is included in the information received from the UDM in operation 605, the AMF may select the same PCF.

In operation 607, the AMF may perform an AM policy association establishment procedure with respect to the UE-PCF used in the EPS (in this instance, the old UE-PCF, new UE-PCF, and new AM-PCF may be the same PCF).

In operation 608, the AMF may transmit, to an SMF+PGW-C, a request message that requests generating a PDU session. The request message in operation 608 may include information (i.e., information related to a change of an RAT) indicating that the type of radio access technology (RAT) that the UE accesses is changed. For example, a method of providing an NR as an RAT type that the UE accesses or providing both E-UTRAN which is a previous RAT type that the UE accessed via the EPS and NR which is the current RAT type that the UE accesses via the 5GS may be included. The request message of operation 608 may include at least one from among the PCF selection assistance information, an indicator (i.e., same PCF selection indication) indicating that the same PCF as the PCF used for the EPS access of UE is selected, and/or the identifier (PCF ID which serving PDN connection) of the PCF that managed the PDN connection of the UE in the EPS before operation 601. In this instance, the information included in the request message of operation 608 may include a portion or the whole of the information that the AMF receives from the UDM in operation 605, or may be information that the AMF provides to the SMF+PGW-C although information is not received from the UDM in operation 605. When the AMF does not receive the information from the UDM in operation 605, the AMF or another NF or an arbitrary network entity may perform determination and transfer corresponding information to the SMF+PGW-C in association with the information included in the request message in operation 608.

In operation 609, the SMF+PGW-C may transmit, to an SM-PCF, a request message that requests modifying an SM policy in association with a PDN connection corresponding to a PDU session to be generated. The request message in operation 609 may include information (i.e., information related to a change of an RAT) indicating that the type of radio access technology (RAT) that the UE accesses is changed. In this instance, the information related to the change of the RAT may include a portion or the whole of the information received from the AMF in operation 608, or may include information that the SMF+PGW-C provides to the SM-PCF although the information related to the change of the RAT is not received from the AMF. When the SMF+PGW-C does not receive the information related to the change of the RAT from the AMF, the SMF+PGW-C or another NF or an arbitrary network entity may perform determination and transfer, to the SM-PCF, corresponding information in association with the change of the RAT. The request message of operation 609 may include at least one from among the PCF selection assistance information, the indicator (i.e., same PCF selection indication) indicating that the same PCF as the PCF used for the EPS access of UE is selected, and/or the identifier (PCF ID which serving PDN connection) of the PCF that managed the PDN connection of the UE in the EPS before operation 601. In this instance, the information included in the request message of operation 609 may include a portion or the whole of the information that the SMF+PGW-C receives from the AMF in operation 608, or may be information that the SMG+PGW-C provides to the SM-PCF although the SMF+PGW-C does not receive information from the AMF in operation 608. When the SMF+PGW-C does not receive the information from the AMF in operation 608, the SMF+PGW-C or another NF or an arbitrary network entity may perform determination and transfer corresponding information to the SM-PCF in association with information included in the request message in operation 609.

In operations 610a, 610b, and 610c, the SM-PCF may determine whether a new PCF is capable of being used in the 5GS, or the PCF used in the EPS needs to be continuously used. Some or all of operations 610a, 610b, and 610c may be performed sequentially/selectively, or in parallel.

In operation 610a, the SM-PCF may determine whether the movement of the UE is inter-system movement (inter-system mobility). In other words, the SM-PCF may determine that the UE has moved from the EPS to the 5GS. Alternatively, the SM-PCF may determine whether the movement of the UE is inter-RAT movement (inter-RAT mobility). In other words, it is determined that the UE has moved from an EPS RAT (e.g., E-UTRAN) to a 5GS RAT (e.g., NR).

In operation 610b, the SM-PCF may determine whether a UE policy association established for the UE that accessed the EPS exists.

In operation 610c, the SM-PCF may determine whether the same PCF as the PCF used in the EPS is capable of being used when the UE moves from the EPS to the 5GS. In the embodiment, a description will be provided on the assumption that the same PCF is used. However, the operation described in the embodiment is not limited to the case in which the same PCF is used.

In operation 6B, the SM-PCF may transmit a request message that requests UE policy modification to an old UE-PCF (i.e., the same PCF) that used in the EPS in operation 611. The request message in operation 611 may include information (i.e., information related to a change of an RAT) indicating that the type of radio access technology (RAT) that the UE accesses is changed. In this instance, the information related to the change of the RAT may be information transferred to the old UE-PCF (i.e., the same PCF), the information being a portion or the whole of the information that the SM-PCF receives from the SMF+PGW-C in operation 609, or may be information that the SM-PCF provides to the old UE-PCF (i.e., the same PCF) although the SM-PCF does not receive information related to the change of the RAT from the SMF+PGW-C. When the SM-PCF does not receive the information related to the change of the RAT from the SMF+PGW-C, the SM-PCF or another NF or an arbitrary network entity may perform determination and transfer, to the old UE-PCF (i.e., the same PCF), corresponding information in association with the change of the RAT. The request message of operation 611 may include at least one from among the PCF selection assistance information, the indicator (i.e., same PCF selection indication) indicating that the same PCF as the PCF used for the EPS access of UE is selected, and/or the identifier (PCF ID which serving PDN connection) of the PCF that managed the PDN connection of the UE in the EPS before operation 601. In this instance, the information included in the request message in operation 611 may include a portion or the whole of the information that the SM-PCF receives from the SMF+PGW-C in operation 609, may be information that the SM-PCF transfers to the old UE-PCF, or may be information that the SM-PCF provides to the old UE-PCF although the SM-PCF does not receive the information from the SMF+PGW-C in operation 609. When the SM-PCF does not receive the information from the SMF+PGW-C in operation 609, the SM-PCF or another NF or an arbitrary network entity may perform determination and transfer corresponding information to the old UE-PCF (i.e., the same PCF) in association with the information included in the request message in operation 611. In addition, the request message in operation 611 may also include an indicator (Indication of UDR-unsubscription not needed) indicating that the old UE-PCF used in the EPS does not need to perform a unsubscribing procedure associated with a UDR. Hereinafter, it is assumed that the old UE-PCF is the same PCF.

In operation 612, the old UE-PCF may obtain a latest UE policy from the UDR via UE policy update, or may provide the latest UE policy to the UDR.

In operation 613, the old UE-PCF may provide the latest UE policy to the SM-PCF and may respond to the UE policy modification request of operation 611.

In operation 614, based on a determination result of operation 610c, the SM-PCF may transmit a response message to the SM+PGW-C in response to the SM policy modification request of operation 609. Hereinafter, a description of the embodiment will describe operation when it is determined that the SM-PCF is to continuously use the PCF used in the EPS in operation 610c. The response message in operation 614 may include information related to a UE policy association. The UE policy association related information may include at least one from among (1) an identifier of a UE-PCF used in the EPS, (2) an identifier of a UE policy association established in the EPS, (3) UE policy information stored in the SM-PCF, and (4) a policy control request trigger stored in the SM-PCF. The information (3) and (4) may be information that the SM-PCF obtains by immediately requesting from the UE-PCF in order to provide the same to the SM+PGW-C. The UE policy information corresponding to the information (3) may include a policy section identifier (PSI) list and/or UE policy data, which may be provided in the form of a UE policy container.

In operation 615, the SMF+PGW-C may transmit, to the AMF, a response message to the PDU session generation request of operation 608. The response may include UE policy association related information. The UE policy association related information may include at least one from among (1) the identifier of the UE-PCF used in the EPS, (2) the identifier of the UE policy association established in the EPS, (3) the UE policy information stored in the SM-PCF, and (4) the policy control request trigger stored in the SM-PCF. The UE policy information corresponding to information (3) may include the policy section identifier (PSI) list and/or UE policy data, which may be provided in the form of a UE policy container. The UE policy association related information may include a portion or the whole of the information that the SMF+PGW-C receives from the SM-PCF in operation 614, and may include information received from the UE-PCF when the SMF+PGW-C has a direct association with the UE-PCF.

In operation 616, the registration of MME with the UDM+HSS may be cancelled.

Referring to FIG. 6C, in operation 617, the MME may request the SGW to delete a session.

In operation 618, when the registration request of UE with the 5GS in operation 601 is accepted, the AMF may transmit an acceptance message to the UE.

In operation 619, the AMF may transmit a request message that requests establishing or modifying a UE policy association to a newly selected UE-PCF. The request message in operation 619 may include at least one of (1) UE policy related information when the UE provides the same to the AMF in operation 601 and (2) a UE policy association identifier. The UE policy related information corresponding to the information (1) may include an indicator indicating that the UE is capable of transmitting/receiving a UE policy via an EPS entity, and this indicator may be included in a UE policy container and may be provided. The UE policy related information corresponding to the information (1) may include information that the AMF receives in operation 615, and the information may be taken into consideration together when the UE-PCF determines a latest UE policy for the UE in operations 621 and 622.

In operation 620, the new UE-PCF may request, from the UDR, UE policy data related subscription.

In operation 621, the new UE-PCF may request and obtain (query) the latest UE policy data from the UDR, or the UDR may provide (notify) the latest UE policy data to the UE-PCF, or the UE-PCF may determine a UE policy for the UE and provide the same to the UDR.

In operation 622, the new UE-PCF may transmit, to the AMF, a response message to the UE policy association establishment/modification request. The response message in operation 622 may include UE policy association related information. The UE policy association related information may include at least one from among (1) an identifier of the new UE-PCF, (2) an identifier of the UE policy association established between the new UE-PCF and the AMF, (3) UE policy information, and (4) a policy control request trigger. The UE policy information of the information (3) may include a policy section identifier (PSI) list and/or UE policy data, which may be provided in the form of a UE policy container.

In operation 623, the AMF may provide the UE policy information to the UE. This process may be performed via a UE configuration update procedure.

FIGS. 7A to 7C are diagrams illustrating a procedure of managing a UE policy association during a process in which a UE moves core network access from the EPS to the 5GS in a wireless communication system that supports interworking between the EPS and the 5GS according to an embodiment of the disclosure. More specifically, FIGS. 7A to 7C illustrate another example of a procedure in which a PCF that was used for an EPS access of UE also manages a UE policy association in the 5GS by using an address of the PCF used for the EPS access of UE when the UE accesses the 5GS.

Referring to FIG. 7A, in operation 701, the UE may transmit a registration request message to an AMF via an NG-RAN. The registration request message in operation 701 may include at least one from among (1) a registration type indicating mobility registration update, (2) handover (or mobility) related information indicating that the UE has moved from the EPS, and (3) a UE policy container including UE policy related information stored in the UE. The UE policy related information included in the UE policy container may include an indicator (e.g., URSP delivery in EPS support indication) indicating that the UE is capable of transmitting/receiving a UE policy via an EPS entity.

In operation 702a, the AMF may request, from an MME, information (context) related to the UE.

In operation 702b, the MME may provide the information (context) related to the UE to the AMF in response to the request of operation 702a. The information related to the UE may include an address of a UE-PCF (e.g., FQDN) capable of being accessed via an interface N101 between a UE-PCF and an SM-PCF and/or via an interface N102 between the UE-PCF and an SMF+PGW-C.

In operation 703, the AMF may select a UDM (or UDM+HSS).

In operation 704, as an NF in charge of UE access and registration management, the AMF may perform UECM registration with the UDM (or UDM+HSS).

In operation 705, the AMF may obtain subscription data of the UE from the UDM (or UDM+HSS).

In operation 706, the AMF may select a PCF for the AMF (i.e., a PCF in charge of an AM policy and a UE policy, a PCF for AMF) (i.e., new AM-PCF/UE-PCF in FIG. 7A).

The operation 706 may include operations 706a and 706b, and the AMF may request, from an NRF, a method of associating with an UE-PCF used in the EPS, when selecting a PCF in operation 706a. In this instance, the AMF may use the address of the UE-PCF received from the MME in operation 702b. For example, the AMF may provide, to the NRF, a first address (e.g., FQDN that enables accessing the UE-PCF by using N101 and/or N102 interface) of the UE-PCF received from the MME in operation 702b, so as to request a second address that enables the AMF to access the UE-PCF). The N101 and/or N102 interface may be referred to as a first interface.

In operation 706b, the NRF may provide, to the AMF, a method of associating with the UE-PCF used in the EPS. In this instance, the NRF may provide the second address that enables the AMF to access the UE-PCF. For example, the NRF may provide, to the AMF, the second address (e.g., FQDN that enables accessing the UE-PCF via the N15 interface) that enables the AMF to access the UE-PCF, which is indicated by the first address of the UE-PCF provided by the AMF in operation 706a, by using an interface (e.g., N15) between the AMF and the UE-PCF. The N15 may be referred to as a second interface. In the operations 706a and 706b in which the AMF requests, from the NRF, the method of associating with the UE-PCF used in the EPS, a request recipient is not limited to the NRF and the request may be transmitted to a UDM, a binding support function (BSF) (not illustrated), or another NF or an arbitrary network entity. The BSF may manage registering/unregistering a PCF as a PCF for UE or session, and may provide a function of providing identification information of a PCF when another NF searches for a PCF for a UE or session. For example, the AMF may request, from the BSF, a method of associating with the UE-PCF used in the EPS in operation 706a. In this instance, the AMF may provide, to the BSF, at least one of an address of the UE (e.g., UE IP address and/or UE MAC address), a UE identifier (e.g., SUPI and/or generic public subscription identifier (GPSI)), a DNN, and S-NSSAI, and may request an address that enables the AMF to access the UE-PCF and/or an identifier of the UE-PCF. The AMF may use an Nbsf management discovery request message. The BSF may provide, to the AMF, the address (e.g., PCF address) that enables the AMF to access the UE-PCF and/or the identifier of the UE-PCF (e.g., PCF instance ID and/or PCF set ID) in operation 707b. The BSF may use an Nbsf management discovery response message.

In operation 707, the AMF may perform an AM policy association establishment procedure with respect to the UE-PCF used in the EPS (in this instance, the old UE-PCF, new UE-PCF, and new AM-PCF may be the same PCF) by using the second address of the UE-PCF provided from the NRF in operation 706b. The AMF may store a PCF ID of the UE-PCF.

In operation 708, the AMF may transmit, to an SMF+PGW-C, a request message that requests generating a PDU session. The request message in operation 708 may include information (i.e., information related to a change of an RAT) indicating that the type of radio access technology (RAT) that the UE accesses is changed. For example, a method of providing an NR as an RAT type that the UE accesses or providing both E-UTRAN which is a previous RAT type that the UE accessed via the EPS and NR which is the current RAT type that the UE accesses via the 5GS may be included. In addition, the request message in operation 708 may include an identifier (PCF ID which serving PDN connection) of a PCF that managed a PDN connection of the UE in the EPS before operation 701. The identifier of the PCF that managed the PDN connection of the UE in the EPS may be the PCF ID that the AMF stores in operation 707.

In operation 709, the SMF+PGW-C may transmit, to an SM-PCF, a request message that requests modifying an SM policy in association with a PDN connection corresponding to a PDU session to be generated. The request message in operation 709 may include information (i.e., information related to a change of an RAT) indicating that the type of radio access technology (RAT) that the UE accesses is changed. In this instance, the information related to the change of the RAT may include a portion or the whole of the information received from the AMF in operation 708, or may include information that the SMF+PGW-C provides to the SM-PCF although the information related to the change of the RAT is not received from the AMF. When the SMF+PGW-C does not receive the information related to the change of the RAT from the AMF, the SMF+PGW-C or another NF or an arbitrary network entity may perform determination and transfer, to the SM-PCF, corresponding information in association with the change of the RAT. In addition, the request message in operation 709 may include the identifier (PCF ID which serving PDN connection) of the PCF that managed the PDN connection of the UE in the EPS before operation 701. The identifier of the PCF that managed the PDN connection of the UE in the EPS may be the PCF ID that the AMF stores in operation 707. In this instance, the information included in the request message of operation 709 may include a portion or the whole of the information that the SMF+PGW-C receives from the AMF in operation 708, or may be information that the SMG+PGW-C provides to the SM-PCF although the SMF+PGW-C does not receive information from the AMF in operation 708. When the SMF+PGW-C does not receive the information from the AMF in operation 708, the SMF+PGW-C or another NF or an arbitrary network entity may perform determination and transfer corresponding information to the SM-PCF in association with information included in the request message in operation 709.

In operations 710a, 710b, and 710c, the SM-PCF may determine whether a new PCF is capable of being used in the 5GS, or the PCF used in the EPS needs to be continuously used. Some or all of operations 710a, 710b, and 710c may be performed sequentially/selectively, or in parallel.

In the operation 710a, the SM-PCF may determine whether the movement of the UE is inter-system movement (inter-system mobility). In other words, the SM-PCF may determine that the UE has moved from the EPS to the 5GS. Alternatively, the SM-PCF may determine whether the movement of the UE is inter-RAT movement (inter-RAT mobility). In other words, it is determined that the UE has moved from an EPS RAT (e.g., E-UTRAN) to a 5GS RAT (e.g., NR).

In operation 710b, the SM-PCF may determine whether a UE policy association established for the UE that accessed the EPS exists.

In operation 710c, whether the same PCF as the PCF used in the EPS is capable of being used when the UE moves from the EPS to the 5GS may be determined. In the embodiment, a description will be provided on the assumption that the same PCF is used.

In operation 711, the SM-PCF may transmit a request message that requests UE policy modification to an old UE-PCF that used in the EPS. The request message in operation 713 may include information (i.e., information related to a change of RAT) indicating that the type of radio access technology (RAT) that the UE accesses is changed. In this instance, the information related to the change of the RAT may be information transferred to the old UE-PCF, the information being a portion or the whole of the information that the SM-PCF receives from the SMF+PGW-C in operation 709, or may be information that the SM-PCF provides to the old UE-PCF (i.e., the same PCF) although the SM-PCF does not receive information related to the change of the RAT from the SMF+PGW-C. When the SM-PCF does not receive the information related to the change of the RAT from the SMF+PGW-C, the SM-PCF or another NF or an arbitrary network entity may perform determination and transfer corresponding information to the old UE-PCF in association with the change of the RAT. In this instance, the information included in the request message in operation 711 may include a portion or the whole of the information that the SM-PCF receives from the SMF+PGW-C in operation 709, may be information that the SM-PCF transfers to the old UE-PCF, or may be information that the SM-PCF provides to the old UE-PCF although the SM-PCF does not receive the information from the SMF+PGW-C in operation 709. When the SM-PCF does not receive the information from the SMF+PGW-C in operation 709, the SM-PCF or another NF or an arbitrary network entity may perform determination and transfer corresponding information to the old UE-PCF in association with the information included in the request message in operation 713. In addition, the request message in operation 711 may include an indicator (Indication of UDR-unsubscription not needed) indicating that the old UE-PCF used in the EPS does not need to perform a unsubscribing procedure associated with a UDR. The request message of operation 711 may include an indicator (i.e., same PCF selection indication) indicating that the same PCF as the PCF used in the EPS access of UE is selected. Hereinafter, it is assumed that the old UE-PCF is the same PCF.

In operation 712, the old UE-PCF may obtain a latest UE policy from the UDR via UE policy update, or may provide the latest UE policy to the UDR.

In operation 713, the old UE-PCF may provide the latest UE policy to the SM-PCF and may respond to the UE policy modification request of operation 711.

In operation 714, based on a determination result of operation 710c, the SM-PCF may transmit a response message to the SM+PGW-C in response to the SM policy modification request of operation 709. The response message may include UE policy association related information. The UE policy association related information may include at least one from among (1) an identifier of a UE-PCF used in the EPS, (2) an identifier of a UE policy association established in the EPS, (3) UE policy information stored in the SM-PCF, and (4) a policy control request trigger stored in the SM-PCF. The information (3) and (4) may be information that the SM-PCF obtains by immediately requesting from the UE-PCF in order to provide the same to the SM+PGW-C. The UE policy information corresponding to the information (3) may include a policy section identifier (PSI) list and/or UE policy data, which may be provided in the form of a UE policy container.

In operation 715, the SMF+PGW-C may transmit, to the AMF, a response message to the PDU session generation request of operation 708. The response may include UE policy association related information. The UE policy association related information may include at least one from among (1) the identifier of the UE-PCF used in the EPS, (2) the identifier of the UE policy association established in the EPS, (3) the UE policy information stored in the SM-PCF, and (4) the policy control request trigger stored in the SM-PCF. The UE policy information corresponding to information (3) may include the policy section identifier (PSI) list and/or UE policy data, which may be provided in the form of a UE policy container. The UE policy association related information may include a portion or the whole of the information that the SMF+PGW-C receives from the SM-PCF in operation 714, and may include information received from the UE-PCF when the SMF+PGW-C has a direct association with the UE-PCF.

Referring to FIG. 7C, in operation 716, the registration of MME with the UDM-HSS may be cancelled.

In operation 717, the MME may request the SGW to delete a session.

In operation 718, when the registration request of UE with the 5GS in operation 701 is accepted, the AMF may transmit an acceptance message to the UE.

In operation 719, the AMF may transmit a request message that requests establishing or modifying a UE policy association to a newly selected UE-PCF. The request message in operation 719 may include at least one of (1) UE policy related information when the UE provides the same to the AMF in operation 701 and (2) a UE policy association identifier. The UE policy related information corresponding to the information (1) may include an indicator indicating that the UE is capable of transmitting/receiving a UE policy via an EPS entity, and this indicator may be included in a UE policy container and may be provided. The UE policy related information corresponding to the information (1) may include information that the AMF receives in operation 715, and the information may be taken into consideration together when the UE-PCF determines a latest UE policy for the UE in steps 21 and 22.

In operation 720, the new UE-PCF may request, from the UDR, UE policy data related subscription.

In operation 721, the new UE-PCF may request and obtain (query) latest UE policy data from the UDR, or the UDR may provide (notify) the latest UE policy data to the UE-PCF, or the UE-PCF may determine a UE policy for the UE and provide the same to the UDR.

In operation 722, the new UE-PCF may transmit, to the AMF, a response message to the UE policy association establishment/modification request. The response message in operation 722 may include UE policy association related information. The UE policy association related information may include at least one from among (1) an identifier of the new UE-PCF, (2) an identifier of a UE policy association established between the new UE-PCF and the AMF, (3) UE policy information, and (4) a policy control request trigger. The UE policy information corresponding to the information (3) may include a policy section identifier (PSI) list and/or UE policy data, which may be provided in the form of a UE policy container.

In operation 723, the AMF may provide the UE policy information to the UE. This process may be performed via a UE configuration update procedure.

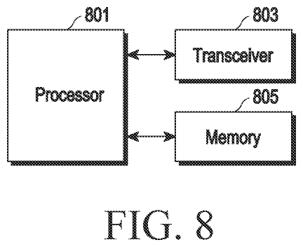

FIG. 8 is a diagram illustrating an example of a configuration of a network entity in a wireless communication system according to an embodiment of the disclosure.

The network entity of FIG. 8 may be one of the network entities described with reference to the embodiments of FIGS. 1 to 4, 5A to 5C, 6A to 6C, and 7A to 7C.

A network entity according to an embodiment of the disclosure may include a processor 801 to control the overall operation of the network entity, a transceiver 803 including a transmitter and a receiver, and memory 805. The network entity is not limited to the example, and may include fewer or more components than the components of FIG. 8.

According to an embodiment of the disclosure, the transceiver 803 may perform signal transmission or reception with other network entities or a UE. The transmitted or received signal may include at least one of control information and data. When the network entity of FIG. 8 is an entity (NF) of a core network, a signal transmitted or received between the network entity and a UE may be transmitted or received via an RAN.

According to an embodiment of the disclosure, the processor 801 may control the overall operation of the corresponding network entity so as to perform operations based on one of the above-described embodiments of FIGS. 1 to 4, 5A to 5C, 6A to 6C, and 7A to 7C or a combination of two or more embodiments thereof. The processor 801, the transceiver 803, and the memory 805 may not be necessarily embodied as separate modules, and may be embodied as a single configuration such as a single chip. In addition, the processor 801 may be an application processor (AP), a communication processor (CP), a circuit, an application-specific circuit, or at least one processor. The transceiver 803 may include at least one communication interface that performs signal transmission or reception with another network entity in a wired/wireless manner.

According to an embodiment, the memory 805 may store data such as a basic program, an application program, configuration information, and the like for operating the corresponding network entity. In addition, the memory 805 may provide data stored therein by request from the processor 801. The memory 805 may be embodied as a storage medium such as ROM, RAM, a hard disk, CD-ROM, a DVD, and the like, or a combination of storage media. In addition, a plurality of pieces of memory 805 may be used. In addition, the processor 801 may perform at least one of the above-described embodiments based on a program stored in the memory 805 and for implementing an operation according to at least one of the embodiments of the disclosure.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

The embodiments of the disclosure described and shown in the specification and the drawings are merely particular examples that have been presented to easily explain the technical contents of the disclosure and help understanding of the disclosure, and are not intended to limit the scope of the disclosure. Therefore, the scope of various embodiments of the disclosure should be construed to include, in addition to the embodiments set forth herein, all changes and modifications derived based on the technical idea of various embodiments of the disclosure. Also, the above respective embodiments may be employed in combination, as necessary.

1. A method performed by an access and mobility management function (AMF) in a wireless communication system that supports interworking between a first network and a second network, the method comprising:
receiving a UE registration request message from a user equipment (UE) that moves from the first network to the second network;
based on first address information related to a first interface for accessing a first policy control function (PCF) used in the first network, obtaining second address information related to a second interface for accessing the first PCF;
based on the second address information, performing a policy association establishment procedure for the first PCF;
transmitting a request message including information related to a change of a radio access technology (RAT) of the UE to a first network entity that manages a protocol data unit (PDU) session for the UE in the second network; and
receiving a response message including UE policy association related information from the first network entity.

2. The method of claim 1, wherein the first PCF and a second PCF are the same PCF.

3. The method of claim 1, wherein the first address information and the second address information are expressed in a fully qualified domain name (FQDN) form.

4. The method of claim 1,
wherein the first network is an EPS and the second network is a 5GS, and
wherein the network access of the UE is moved from the EPS to the 5GS.

5. An access and mobility management function (AMF) in a wireless communication system that supports interworking between a first network and a second network, the AMF comprising:
a transceiver; and
a processor configured to:
receive, via the transceiver, a UE registration request message from a UE that moves from the first network to the second network,
based on first address information related to a first interface for accessing a first policy control function (PCF) used in the first network, obtain second address information related to a second interface for accessing the first PCF,
based on the second address information, perform a policy association establishment procedure with respect to the first PCF,
transmit, via the transceiver, a request message including information related to a change of a radio access technology (RAT) of the UE to a first network entity that manages a protocol data unit (PDU) session for the UE in the second network, and
receive, via the transceiver, a response message including UE policy association related information from the first network entity.

6. The AMF of claim 5, wherein the first PCF and the second PCF are the same PCF.

7. The AMF of claim 5, wherein the first address information and the second address information are expressed in a fully qualified domain name (FQDN) form.

8. The AMF of claim 5,
wherein the first network is an EPS and the second network is a 5GS, and
wherein the network access of the UE is moved from the EPS to the 5GS.

9. A method performed by a session management-policy control entity (session management-policy control function (SM-PCF)) in a wireless communication system that supports interworking between a first network and a second network, the method comprising:
receiving a request message, including information related to a change of a radio access technology (RAT) of a UE, for modifying a session management policy, from a first network entity that receives a PDU session establishment request from the UE that moves from the first network to the second network;
determining whether a policy control function (PCF) used in the first network for the UE is used in the second network; and
based on the determination, transmitting a response message including UE policy association related information to the first network entity.

10. The method of claim 9, wherein the UE policy association related information comprises at least one from among an identifier of the PCF used in the first network, an identifier of a UE policy association established in the first network, UE policy information stored in the SM-PCF, and a policy control request trigger stored in the SM-PCF.

11. The method of claim 9,
wherein the first network is an EPS and the second network is a 5GS, and
wherein the network access of the UE is moved from the EPS to the 5GS.

12. A session management-policy control entity (session management-policy control function (SM-PCF)) in a wireless communication system that supports interworking between a first network and a second network, the SM-PCF comprising:
a transceiver; and
a processor configured to:
receive, via the transceiver, a request message, including information related to a change of a radio access technology (RAT) of a UE, for modifying a session management policy, from a first network entity that receives a PDU session establishment request from the UE that moves from the first network to the second network,
determine whether a policy control function (PCF) used in the first network for the UE is used in the second network, and
based on the determination, transmit a response message including UE policy association related information to the first network entity via the transceiver.

13. The SM-PCF of claim 12, wherein the UE policy association related information comprises at least one from among an identifier of the PCF used in the first network, an identifier of a UE policy association established in the first network, UE policy information stored in the SM-PCF, and a policy control request trigger stored in the SM-PCF.

14. The SM-PCF of claim 12,
wherein the first network is an EPS and the second network is a 5GS, and
wherein the network access of the UE is moved from the EPS to the 5GS.
